(19) United States
(12) Patent Application Publication
(10) Pub. No.: US 2021/0154749 A1
(43) Pub. Date: May 27, 2021

(54) DRILL BIT

(71) Applicant: MILWAUKEE ELECTRIC TOOL CORPORATION, Brookfield, WI (US)

(72) Inventors: Brett A. Parendo, Arvada, CO (US); Alexander R. Greenhill, St. Louis, MO (US); David Hlavac, Germantown, WI (US); Carter A. Gibson, Wauwatosa, WI (US)

(21) Appl. No.: 16/965,385

(22) PCT Filed: Jan. 25, 2019
(86) PCT No.: PCT/US2019/015074

§ 371 Date: Jul. 28, 2020

Related U.S. Application Data
(60) Provisional application No. 62/623,013, filed on Jan. 29, 2018.

(51) Int. Cl. B23B 51/02

(52) U.S. Cl. CPC B23B 51/02

(57) ABSTRACT

A drill bit includes a body having a first end, a second end opposite the first end, and an axis of rotation extending centrally though the body from the first end to the second end. The body defining an outer diameter. The drill bit also includes a shank adjacent the second end of the body configured to couple to a tool and a cutting head adjacent the first end. The cutting head includes a plurality of axially stacked, progressively sized steps including a first step and a terminal step positioned between the first step and the first end of the body. The steps increase in diameter from the first step to the terminal step. The terminal step having a diameter that is less than or equal to the outer diameter.

### CROSS REFERENCE TO RELATED APPLICATIONS

This application claims priority to U.S. Provisional Patent Application No. 62/623,013, filed Jan. 29, 2018, the entire contents of which are incorporated herein by reference.

### BACKGROUND

The present invention relates to drill bits

Drill bits are generally used with power tools such as rotary drills or hammer-type drills to cut or carve holes into a material or surface. Drill bits are used to cut holes into a variety of materials such as brick, block, tile, metal, marble, concrete, plaster, wood, plastic, dry-wall, etc., or any combination thereof. Drill bits need to be versatile, but also need to be durable to withstand drilling in abrasive materials.

### SUMMARY

In one embodiment, the invention provides a drill bit including a body having a first end, a second end opposite the first end, and an axis of rotation extending centrally though the body from the first end to the second end. The body defines an outer diameter. The drill bit also includes a shank adjacent the second end of the body configured to couple to a tool and a cutting head adjacent the first end. The cutting head includes a plurality of axially stacked, progressively sized steps including a first step and a terminal step positioned between the first step and the first end of the body. The steps increase in diameter from the first step to the terminal step. The terminal step has a diameter that is less than or equal to the outer diameter.

In another embodiment, the invention provides a drill bit including a body having a first end, a second end opposite the first end, and an axis of rotation extending centrally through the body from the first end to the second end. The body defines an outer diameter. The drill bit also includes a shank adjacent the second end of the body configured to couple to a tool and a cutting head adjacent the first end. The cutting head includes a cutting tip and a plurality of axially stacked, progressively sized steps including a first step adjacent the cutting tip and a terminal step positioned between the first step and the first end of the body. The steps increase in diameter from the first step to the terminal step. The terminal step having a diameter that is less than or equal to the outer diameter. The drill bit further includes a flute helically wrapped around the body. The flute extends from the cutting tip toward the shank along a length of the body.

In another embodiment the invention provides a drill bit including a body having a first end, a second end opposite the first end, and an axis of rotation extending centrally through the body from the first end to the second end. The body defines an outer diameter The drill bit also includes a shank adjacent the second end of the body configured to couple to a tool and a cutting head adjacent the first end. The cutting head includes a plurality of axially stacked, progressively sized steps including a first step and a terminal step positioned between the first step and the first end of the body. Each of the plurality of steps include outer periphery surfaces, a diameter defined between the outer periphery surfaces in a direction perpendicular to the axis of rotation, and taper surfaces that connect respective periphery surfaces to consecutive steps. The diameter of each step increases in size from the first step to the terminal step. The diameter of the terminal step being less than or equal to the outer diameter.

Other aspects of the invention will become apparent by consideration of the detailed description and accompanying drawings.

### BRIEF DESCRIPTION OF THE DRAWINGS

FIG. 1 is an elevational view of a drill bit.

FIG. 2 is an end view of the drill bit of FIG. 1.

FIG. 3 is an enlarged side view of a cutting head of the drill bit of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

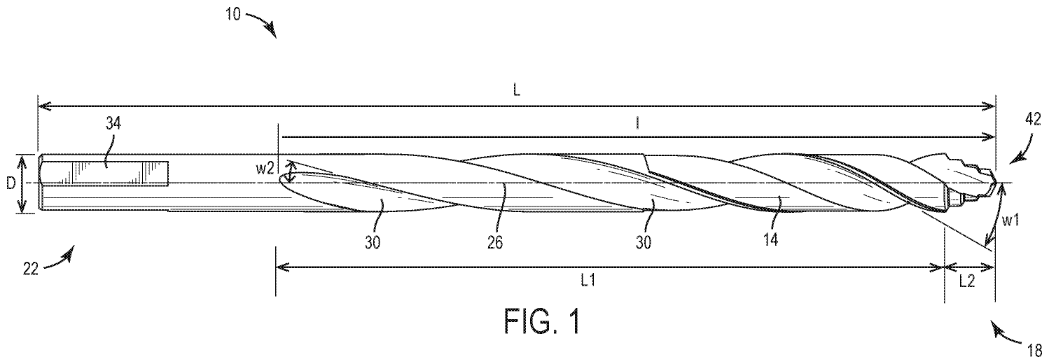

FIGS. 1-3 illustrate a drill bit 10 for use with a power tool, such as, for example, a drill, a driver drill, a screwdriver, and the like. The drill bit 10 may be used to cut holes or drill into a workpiece made out of brick, block tile, metal, marble, concrete, plaster, wood, plastic, dry-wall, and the like. The illustrated drill bit 10 comes in a variety of sizes that correspond to the diameter of a hole to be created in a workpiece. For example, possible sizes of the drill bit 10 may be 3 mm, 6 mm, 10 mm, and 13 mm. Additionally, the size of the drill bit may be ⅛″, ¼″, or ½″. In other embodiments, the drill bit 10 may be other sizes.

With reference to FIG. 1, the drill bit 10 includes a body 14 having a first or workpiece-engaging end 18, a second or rearward end 22 configured to be received in a tool holder or chuck of a power tool, an axis of rotation 26 centrally located on the drill bit 10 from the first end 18 to the second end 22, and flutes 30. The drill bit 10 may come in a variety of different lengths L defined between the first end 18 and the second end 22. In some embodiments, the length L of the drill bit 10 may be based, at least in part, on the diameter of the drill bit 10. In some embodiments, the length L of the drill bit 10 is in a range between 45 mm to 152 mm. Further, a length L1 of the body 14, measured in a direction parallel to the axis of rotation 26, is defined between the first and second ends 18, 22. The diameter D of the drill bit 10, and specifically of the body 14, is in a range of 3 mm to 15 mm.

With continued reference to FIG. 1, the second end 22 of the drill bit 10 includes a shaft or shank 34 that is configured to be coupled to a tool. In the illustrated embodiment, the shank is a 3-flat shank. In other embodiments, the shank 34 may be a hex-shaped shank, round shank or other suitable shapes to be received in a power tool. The shank 34 is approximately one sixth to one tenth the total length L of the drill bit 10. The shank 34 may include laser etchings indicating to the user the size of the drill bit 10. In some embodiments, the shank 34 may be integrally formed with the drill bit 10. In other embodiments, the shank 34 may be welded to the drill bit 10 or coupled using adhesive or other means.

In the illustrated embodiment, the drill bit 10 includes two flutes 30. In other embodiments, the drill bit 10 may include fewer or more flutes 30. The flutes 30 are helically wrapped around the body 14 of the drill bit 10 and extend from the first end 18 of the body to the shank 34. Preferably, the flutes 30 are at least half the length L of the entire drill bit 10. Even more preferably, the flutes 30 have a length l between 20 mm and 114 mm. The flutes 30 are helically wrapped around the body 14 at a variable helix angle. In other words, the angle at which the flutes 30 wrap about the body 14 change as the flutes 30 extend from the first end 18 to the shank 34. In the illustrated embodiment, a helix angle W1 of each flute 30 adjacent the first end 18 is larger than a helix angle W2 of each flute 30 adjacent the shank 34. Preferably, the helix angle W1 of each flute 30 adjacent the first end 18 is approximately 35 degrees, and the helix angle W2 of each flute 30 adjacent the shank 34 is between 15 degrees and 20 degrees. In some embodiments, the helix angles of the flutes 30 may gradually transition from the first helix angle W1 to the second helix angle W2. In further embodiments, the flutes 30 may have a constant helix angle.

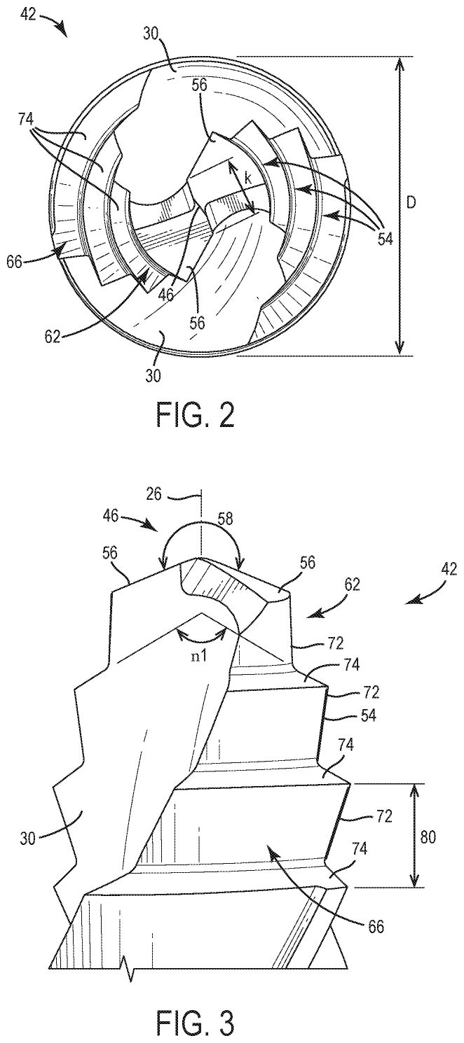

With reference to FIGS. 2-3, the drill bit 10 further includes a cutting head 42 extending from the first end 18 of the body 14. In some embodiments, the cutting head 42 is separately formed and may be secured to the body 14 (e.g., welded). The cutting head 42 defines a length L2 (FIG. 1) measured in a direction parallel to the axis of rotation 26. In some embodiments, the length L2 of the cutting head 42 is less than half of the length L1 of the body 14. In other embodiments, the length L2 of the cutting head 42 is less than one third of the length L of the body 14. In further embodiments, the length L2 of the cutting head 42 is less than one quarter of the length L1 of the body 14. In the illustrated embodiment, the length L2 of the cutting head 42 is about one tenth of the length L1 of the body 14. The cutting head 42 includes a cutting tip 46 and a plurality of steps 54. The cutting tip 46 has two side surfaces 56 that define a cutting tip angle 58 (FIG. 3) measured through the axis of rotation 26. The cutting tip angle 58 is an oblique angle. More particularly, the cutting tip angle 58 may be within a range between 130 degrees and 140 degrees. In some embodiments, the cutting tip angle 58 is 135 degrees.

As shown in FIG. 2, the drill bit 10 further includes a web K that is defined as the width between the two flutes 30. The web K extends the full length 1 of the flutes 30. In some embodiments, the web K tapers from the second end 22 to the first end 18. In other words, the web K increases in thickness from the first end 18 to the second end 22. In the illustrated embodiment, the length of the web K at the cutting tip 46 is approximately one sixth the diameter D of the drill bit 10. Preferably, the length of the web K at the cutting tip 46 is between 0.5 mm and 2 mm.

The plurality of steps 54 includes a first step 62 of the drill bit 10 and a terminal step 66 positioned between the first step 62 and the second end 22 of the drill bit 10. The terminal step is adjacent the first end 18 of the body 14. In some embodiments, the first step 62 and the cutting tip 46 may be referred to as a pilot tip. The pilot tip assists in centering the drill bit 10 for drilling into a workpiece. The plurality of steps 54 are axially stacked between the first step 62 and the terminal step 66 and increase in diameter from the first step 62 to the terminal step 66. In the illustrated embodiment, the diameter between consecutive steps 54 increases from the first step 62 to the terminal step 66 in equal increments. In other embodiments, the diameter between consecutive steps 54 increases from the first step 62 to the terminal step 66 in unequal increments. In some embodiments, the diameter between consecutive steps 54 increases within a range between 1 mm and 2 mm.

In the illustrated embodiment, the cutting head 42 includes three steps 54. In other embodiments, the cutting head 42 may include between two and six steps 54 (e.g., a first step, a second step, a third step, a fourth step, a fifth step, and sixth or terminal step). In further embodiments, the cutting head 42 may include more than six steps 54. In some embodiments, larger diameter drill bits may include more steps, while smaller diameter drill bits may include fewer steps.

In the illustrated embodiment, each step 54 includes an outer periphery surface 72 that is approximately parallel to the axis of rotation 26 and a taper surface 74 that connects the outer periphery surface 72 to consecutive steps 54. The taper surface 74 may be considered a secondary cutting angle. Each of the plurality of steps 54 includes two taper surfaces 74 and two outer periphery surfaces 72. Each taper surface 74 and each outer periphery surface 72 is positioned on one side of the cutting head 42. In other words, each taper surface 74 and each outer periphery surface 72 is positioned on diametrically opposite sides of the axis of rotation 26 from one another. Each taper surface 74 is substantially the same, similarly, each outer periphery surface 72 is the same. In other embodiments, each step 54 may include more than two taper surfaces 74 and two outer periphery surfaces 72. The taper surfaces 74 and the outer periphery surfaces 72 for each of the plurality of steps 54 are separated by the flutes 30.

In the illustrated embodiment, the taper surfaces 74 for each step 54 define a step angle n1 measured through the axis of rotation 26. The step angle n1 is an oblique angle. More particularly, the step angle n1 is within a range between 100 degrees and 160 degrees. In some embodiments, the step angle n1 is 118 degrees. In the illustrated embodiment, each step 54 has the same step angle n1. In other embodiments, the step angle n1 may vary for each step 54.

With reference to FIG. 3, each step 54 has a height 80 measured in a direction parallel to the axis of rotation 26 between consecutive steps 54. In the illustrated embodiment, the height 80 of each step 54 is defined as the axial component of both the taper surface 74 and the outer periphery surface 72. In other words, the axial component is the component or distance that is parallel to the axis of rotation 26. The axial component of the taper surface 74 is approximately one-fifth to one-third the total height 80 of the step 54. In some embodiments, the height 80 is the same for all the steps 54. In other embodiments, the height 80 of the steps 54 may vary between consecutive steps 54. Preferably, the height 80 of the steps 54 is in a range between 1 mm and 3 mm. In the illustrated embodiment, a ratio, defined as the difference in diameter between consecutive steps 54 divided by the height 80 of each of the plurality of steps 54, is greater than one-half. More particularly, the ratio is between three-fifths and two-thirds.

In some embodiments, the drill bit 10 may include a rust preventive coating that is applied to the entire drill bit 10. In further embodiments, the drill bit 10 may be coated with a PVD (physical vapor deposition) coating, such as titanium-nitride, or with black oxide.

Various features and advantages of the invention are set forth in the following claims.

What is claimed is:

1. A drill bit comprising:
a body having a first end, a second end opposite the first end, and an axis of rotation extending centrally though the body from the first end to the second end, the body defining an outer diameter;
a flute that extends at least partially between the first and second ends;
a shank adjacent the second end of the body, the shank configured to couple to a tool; and
a cutting head adjacent the first end, the cutting head including a plurality of axially stacked, progressively sized steps including a first step and a terminal step positioned between the first step and the first end of the body, the steps increasing in diameter from the first step to the terminal step, the terminal step having a diameter that is less than or equal to the outer diameter.

2. The drill bit of claim 1, wherein the diameter between consecutive steps increases equally from the first step to the terminal step.

3. The drill bit of claim 2, wherein the diameter increases between consecutive steps within a range between 1 mm and 2 mm.

4. The drill bit of claim 1, wherein the plurality of steps includes at least three steps.

5. The drill bit of claim 1, wherein a height defined in a direction parallel to the axis of rotation between consecutive steps is the same for all steps.

6. The drill bit of claim 5, wherein the height is within a range between 1 mm and 3 mm.

7. The drill bit of claim 1, wherein each step of the plurality of steps includes outer periphery surfaces, a diameter defined between the outer periphery surfaces in a direction perpendicular to the axis of rotation, and taper surfaces that connect respective outer periphery surfaces to consecutive steps.

8. The drill bit of claim 1, wherein the body has a first length measured parallel to the axis of rotation and the cutting head has a second length measured parallel to the axis of rotation, and wherein the second length is less than one half the first length.

9. A drill bit comprising:
a body having a first end, a second end opposite the first end, and an axis of rotation extending centrally through the body from the first end to the second end, the body defining an outer diameter;
a shank adjacent the second end of the body, the shank configured to couple to a tool;
a cutting head adjacent the first end, the cutting head including a cutting tip and a plurality of axially stacked, progressively sized steps including a first step adjacent the cutting tip and a terminal step positioned between the first step and the first end of the body, the steps increasing in diameter from the first step to the terminal step, the terminal step having a diameter that is less than or equal to the outer diameter; and
a flute helically wrapped around the body, the flute extending from the cutting tip toward the shank along a length of the body.

10. The drill bit of claim 9, wherein the flute is a first flute and the drill bit further comprises a second flute helically wrapped around the body, the second flute extending the length of the body.

11. The drill bit of claim 10, wherein the body defines a web extending between the first and second flutes.

12. The drill bit of claim 11, wherein the web increases in thickness from the first end to the second end.

13. The drill bit of claim 9, wherein the flute is wrapped around the body at a variable helix angle.

14. The drill bit of claim 13, wherein a helix angle of the flute at a position adjacent the first end of the body is between 18 degrees and 35 degrees, and wherein a helix angle of the flute at a position adjacent the second end of the body is between 15 and 25 degrees.

15. The drill bit of claim 9, wherein the cutting tip includes two side surfaces that define a cutting tip angle measured through the axis of rotation, and wherein the cutting tip angle is oblique.

16. The drill bit of claim 15, wherein the cutting tip angle is within a range between 130 degrees and 140 degrees.

17. A drill bit comprising:
a body having a first end, a second end opposite the first end, and an axis of rotation extending centrally through the body from the first end to the second end, the body defining an outer diameter;
a shank adjacent the second end of the body, the shank configured to couple to a tool; and
a cutting head adjacent the first end of the body, the cutting head including a plurality of axially stacked, progressively sized steps including a first step and a terminal step positioned between the first step and the first end of the body, each of the plurality of steps including outer periphery surfaces, a diameter defined between the outer periphery surfaces in a direction perpendicular to the axis of rotation, and taper surfaces that connect respective periphery surfaces to consecutive steps, the diameter of each step increasing in size from the first step to the terminal step, the diameter of the terminal step being less than or equal to the outer diameter.

18. The drill bit of claim 17, wherein a height of each step is defined in a direction parallel to the axis of rotation between consecutive steps, wherein the height includes an axial component of the taper surface and an axial component of the outer periphery surface.

19. The drill bit of claim 18, wherein the axial component of the taper surface is between one-fifth and one-third the height.

20. The drill bit of claim 17, wherein a ratio defined as the height divided by a difference in diameter between consecutive steps is greater than 3:2.

21. The drill bit of claim 17, wherein the taper surfaces and the respective outer periphery surfaces are separated by a flute that extends at least partially between the first and second ends.

22. The drill bit of claim 17, wherein the taper surfaces of each step define a step angle measured through the axis of rotation, and wherein the step angle is an oblique angle.

23. The drill bit of claim 22, wherein the step angle is the same for each step.

24. The drill bit of claim 22, wherein the step angle is within a range between 100 degrees and 160 degrees.

25. The drill bit of claim 24, wherein the step angle is 118 degrees.
